(19) United States
(12) Patent Application Publication
(10) Pub. No.: US 2026/0271935 A1
(43) Pub. Date: Sep. 17, 2026

(54) PHOSPHOLIPID COMPOSITION COMPRISING SURFACTANT, AND USE THEREOF

(71) Applicant: SBLBIO CO., LTD., Siheung-si (KR)

(72) Inventors: Guk Hoon CHUNG, Seongnam-si (KR); Ji Heun HONG, Yongin-si (KR); Hyoung Il LIM, Seongnam-si (KR)

(21) Appl. No.: 19/673,928

(22) Filed: May 11, 2026

Related U.S. Application Data
(63) Continuation of application No. PCT/KR2024/016504, filed on Oct. 28, 2024.

(30) Foreign Application Priority Data
Nov. 9, 2023 (KR) 10-2023-0154697

(51) Int. Cl. A01N 57/12; A01N 25/02; A01N 25/30; A01P 21/00

(52) U.S. Cl. CPC A01N 57/12; A01N 25/02; A01N 25/30; A01P 21/00

(57) ABSTRACT

The phospholipid composition comprising a surfactant, according to the present invention, comprises lysophospholipid and a sulfosuccinate-based surfactant, thereby allowing lysophospholipid, which is the active ingredient, to be well dispersed even in an aqueous solution, and the active ingredient does not readily decompose even during long-term storage, and the efficacy thereof can be maintained for a long period of time. Therefore, the phospholipid composition of the present invention can be stored for a long period of time by inhibiting decomposition of lysophospholipid, which is the active ingredient, and thus can be used commercially and more easily than a conventional pesticide composition having a short shelf life.

### CROSS-REFERENCE TO RELATED APPLICATION

This application is a continuation of pending PCT International Application No. PCT/KR2024/016504, filed on Oct. 28, 2024, which claims priority to Korean Patent Application No. 10-2023-0154697 filed on Nov. 9, 2023, the entire contents of which are hereby incorporated by references in its entirety.

### TECHNICAL FIELD

The present invention relates to a phospholipid composition, and more specifically, to a phospholipid composition including a surfactant.

### BACKGROUND ART

Lysophosphatidylethanolamine (LPE) is naturally present in plant and animal cells, and is particularly abundant in egg yolks and brain cells. LPE is derived from phosphatidylethanolamine (PE), a type of phospholipid found in cell membranes. PE, which is abundant in egg yolks and soybean lecithin, is a type of phospholipid containing two fatty acids within the molecule thereof. PE is converted into LPE in vivo as one fatty acid is removed through the action of phospholipase A2, a phospholipid hydrolyzing enzyme.

LPE is known to play a critical role in the ripening and senescence of fruits. Treatment with LPE is known to inhibit the senescence of tomato leaves and fruits, and post-harvest treatment of tomatoes with LPE is also known to extend the storage period of the fruits. In addition, when applied to apples, LPE is known to promote the formation of anthocyanin in the peel and inhibit the softening during the storage of harvested apples. (Related Patent Documents 1 and 2: U.S. Pat. Nos. 5,110,341 and 5,126,155)

As described above, LPE is a substance that is very useful in the agricultural field, but the ester bonds formed by fatty acids in the chemical structure thereof are highly susceptible to hydrolysis reactions caused by the addition of water molecules, which presents a disadvantage in that it is difficult to maintain a stable formulation of LPE in aqueous solutions and store the same for a long period. In the case of commercially available 10% aqueous LPE solutions, precipitates generally form at low temperatures below 20° C., or the active ingredients decompose rapidly at temperatures above room temperature. In other words, while it is commercially significant to have a long shelf life and increase the content of LPE as an active ingredient, which has a chemical structure susceptible to hydrolysis, an effective solution to this problem remains elusive.

### DETAILED DESCRIPTION OF THE INVENTION

### Technical Problem

To solve the above-described problems, a problem that the present invention aims to solve is to provide a water-soluble phospholipid composition including a surfactant.

To solve the above-described problems, another problem that the present invention aims to solve is to provide a method of treating a plant or a part of a plant with the phospholipid composition to alter the health status, growth, or life cycle thereof.

To solve the above-described problems, still another problem that the present invention aims to solve is to provide various uses of the water-soluble phospholipid composition including the surfactant.

Meanwhile, the technical problems of the present invention are not limited to the above-mentioned problems, and other technical problems that are not mentioned will be clearly understood by a person skilled in the art from the description below.

### Technical Solution

To solve the above-described problems, one aspect of the present invention may include a lysophospholipid represented by Chemical Formula 1 and a sulfosuccinate-based surfactant represented by Chemical Formula 2.

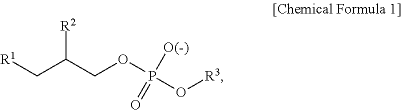

In Chemical Formula 1, R1 is any one selected from a C5 to C24 saturated or unsaturated straight-chain acyloxy group, a C5 to C24 saturated or unsaturated straight-chain alkoxy group, and derivatives thereof;

R2 is any one selected from hydrogen, a hydroxy group, a C1 to C5 saturated or unsaturated straight-chain acyloxy group, and a C1 to C5 saturated or unsaturated straight-chain alkoxy group; and

R3 is any one selected from hydrogen, choline, ethanolamine, glycerol, inositol, and serine.

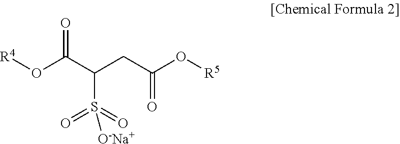

In Chemical Formula 2, R4 and R5 are each independently hydrogen, sodium, or a C1 to C18 saturated or unsaturated, straight-chain or branched alkyl group, and R4 and R5 are not both hydrogen or both sodium.

The derivatives may include at least one hydroxy group bonded to at least one carbon within the chemical structure of R1.

The phospholipid composition may be a water-soluble composition in liquid or powder form.

The lysophospholipid may have a concentration of 0.1% to 20% by weight based on a total weight of the phospholipid composition.

The sulfosuccinate-based surfactant is included in an amount of 0.1% to 20% by weight based on a total weight of the phospholipid composition.

The phospholipid composition may further include a fatty acid additive including: a C6 to C24 saturated or unsaturated straight-chain fatty acid; a fatty acid metal salt containing a metal salt of any one selected from Na, K, Mg, Ca, and Al; a fatty acid organic salt containing an organic salt of any one selected from an ethanolamine salt, an ammonium salt, betaine, and a choline salt; or a combination of two or more thereof.

The fatty acid additive may be included in an amount of 1% to 20% by weight based on a total weight of the phospholipid composition.

The phospholipid composition may further include an organic solvent including: a monohydric alcohol including at least one selected from ethanol, propanol, butanol, hexanol, octanol, and a combination thereof; a dihydric alcohol including at least one selected from 1,3-butanediol, 2,3-butanediol, propanediol, hexanediol, octanediol, and a combination thereof; a trihydric alcohol including glycerol; and a mixture of two or more thereof.

The phospholipid composition may further include lecithin, hydroxylated lecithin, acetylated lecithin, enzyme-treated lecithin, or a combination of two or more thereof.

In order to solve the other problem described above, another aspect of the present invention may include a method including a step of treating a plant or a part of a plant with a plant treatment agent including a phospholipid composition to alter health status, growth, or life cycle of the plant or the part of the plant.

The phospholipid composition including a lysophospholipid represented by Chemical Formula 1 and a sulfosuccinate-based surfactant represented by Chemical Formula 2.

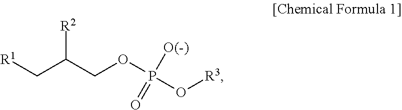

In Chemical Formula 1, R1 is any one selected from a C5 to C24 saturated or unsaturated straight-chain acyloxy group, a C5 to C24 saturated or unsaturated straight-chain alkoxy group, and derivatives thereof;

R2 is any one selected from hydrogen, a hydroxy group, a C1 to C5 saturated or unsaturated straight-chain acyloxy group, and a C1 to C5 saturated or unsaturated straight-chain alkoxy group; and

R3 is any one selected from hydrogen, choline, ethanolamine, glycerol, inositol, and serine.

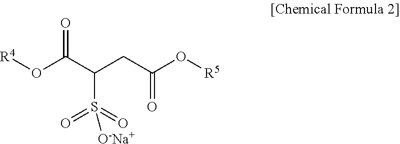

In Chemical Formula 2, R4 and R5 are each independently hydrogen, sodium, or a C1 to C18 saturated or unsaturated, straight-chain or branched alkyl group, and R4 and R5 are not both hydrogen or both sodium.

The derivatives may include at least one hydroxy group bonded to at least one carbon within the chemical structure of R1.

The plant treatment agent may be an aqueous solution including the lysophospholipid at a concentration of 1 to 5,000 ppm (w/w).

The part of the plant may be at least one selected from fruit, leaf, flower, root, stem, and tuber.

The plant treatment agent may be a water-soluble composition in liquid or powder form.

The plant treatment agent may further include at least one selected from lecithin, hydroxylated lecithin, acetylated lecithin, enzyme-treated lecithin, and a combination thereof.

The method may improve a quality attribute of a plant or a part of a plant.

The quality attribute may include at least one selected from color, flavor, hardness, sugar content, fruit cracking, and odor.

The method may delay senescence of a plant or a part of a plant.

The delaying the senescence may be extending a storage period or shelf life of a plant or a part of a plant.

The method may stimulate growth of a plant or a part of a plant to increase at least one selected from diameter, width, weight, and number of fruit, vegetable, root, and/or tuber thereof.

The method may protect a plant or a part of a plant from biotic or abiotic stress.

The abiotic stress may include physical damage caused by at least one abiotic factor selected from freezing, wind, hail, flooding, drought, heat, and pesticides.

The pesticide may include at least one selected from plant growth regulators, insecticides, fungicides, herbicides, spreader-stickers, and fertilizers.

The biotic stress may include physical damage caused by a biotic factor including at least one of pathogens, insects, nematodes, snails, mites, weeds, humans, and animals other than humans.

The pathogen may include at least one of fungi, protozoa, bacteria, and viruses.

The method may increase synthesis of a component selected from starch, protein, lipid, and a combination of two or more thereof in a plant or a part of a plant.

### Advantageous Effects

The phospholipid composition including the surfactant according to the present invention includes a lysophospholipid and a sulfosuccinate-based surfactant, thereby allowing lysophospholipid, which is the active ingredient, to be well dispersed even in an aqueous solution, and the active ingredient does not readily decompose even during long-term storage, and the efficacy thereof can be maintained for a long period of time. Therefore, the phospholipid composition of the present invention can be stored for a long period of time by inhibiting decomposition of lysophospholipid, which is the active ingredient, and thus can be used commercially and more easily than a conventional pesticide composition having a short shelf life.

The effects of the present invention are not limited to the above-mentioned effects, and other effects that are not mentioned will be clearly understood by those skilled in the art from the description below.

### DESCRIPTION OF THE DRAWINGS

FIG. 1 shows the results of testing the change in residual amount during the storage period according to the type of water-soluble phospholipid composition with improved long-term storage stability according to an embodiment of the present invention.

FIG. 2 shows the results of testing the control effect against kiwi canker disease using the phospholipid composition according to an embodiment of the present invention.

FIG. 3 shows the results of testing the inhibitory effect against cold damage occurrence in Hongro variety apple using the phospholipid composition according to an embodiment of the present invention.

FIG. 4 shows the results of testing the change in skin color of Hongro variety apples before harvest using the phospholipid composition according to an embodiment of the present invention.

FIG. 5 shows the results of testing the coloration promotion in Picnic variety apples using the phospholipid composition according to an embodiment of the present invention.

FIG. 6 shows the results of testing the coloration promotion in Campbell Early variety grapes using the phospholipid composition according to an embodiment of the present invention.

FIG. 7 shows the results of testing the coloration promotion in Picnic variety apples using the phospholipid composition seven days after preparation according to an embodiment of the present invention.

FIG. 8 shows the results of measuring the change in skin color of Picnic variety apples using the phospholipid composition one year after preparation according to an embodiment of the present invention.

FIG. 9 shows the results of testing the coloration promotion in Campbell Early variety grapes using the phospholipid composition seven days after preparation according to an embodiment of the present invention.

FIG. 10 shows the results of observing the change in skin color of Campbell Early variety grapes using the phospholipid composition one year after preparation according to an embodiment of the present invention.

### BEST MODE

The present invention may have various modifications and may be embodied in many different forms, and specific embodiments are illustrated in the drawings and described in detail in the text. However, this is not intended to limit the present invention to the specific disclosed forms, and should be understood to include all modifications, equivalents, and substitutes included within the spirit and technical scope of the present invention. Like reference numerals have been used for like elements throughout the description of each drawing.

Unless otherwise defined, all terms, including technical and scientific terms used herein, have the same meaning as generally understood by one of ordinary skill in the art to which the present invention pertains. Terms, such as those defined in commonly used dictionaries, should be interpreted as having a meaning that is consistent with their meaning in the context of the relevant art and are not interpreted in an idealized or overly formal sense unless explicitly defined in the present invention.

Throughout the present specification, when a part is said to “comprise” a certain element, unless otherwise specified, it means that other elements may be further included rather than excluding other elements.

Throughout the whole document, the terms “about or approximately” or “substantially” are intended to have meanings close to numerical values or ranges specified with an allowable error and intended to prevent accurate or absolute numerical values disclosed for understanding of the present invention from being illegally or unfairly used by any unconscionable third party.

Throughout the present specification, when a substance (solute) is referred to as being “dispersed” or “dissolved” in a composition (solvent), this means that the solute is dissolved in the solvent in a transparent, stable, and homogeneous state without precipitation.

### Phospholipid Composition

Water-soluble formulations containing LPE, which is registered as a pesticide in the United States, have a problem in that the degradation rate of LPE increases and the residual amount of LPE decreases over time as the storage temperature increases. In particular, when the temperature is 80° C., almost all LPE decomposes within one month. Meanwhile, at room temperature, product stability is maintained to some extent up to 120 days, but it is difficult to maintain a shelf life of more than one year, as there is typically a loss of 20% or more of LPE after six to eight months following the production of the product. In contrast, the preferred phospholipid composition according to the present invention includes the active ingredient lysophospholipid and a sulfosuccinate-based surfactant, thereby improving dispersibility in an aqueous solvent and inhibiting decomposition of the active ingredient, so that a shelf life of at least two years or more can be secured.

First, the phospholipid composition of the present invention may include lysophospholipid represented by a lysophospholipid represented by Chemical Formula 1 below.

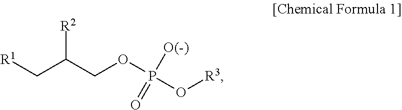

In Chemical Formula 1, R1 may be any one selected from a C5 to C24 saturated or unsaturated straight-chain acyloxy group, a C5 to C24 saturated or unsaturated straight-chain alkoxy group, and derivatives thereof; R2 may be any one selected from hydrogen, a hydroxy group, a C1 to C5 saturated or unsaturated straight-chain acyloxy group, and a C1 to C5 saturated or unsaturated straight-chain alkoxy group; and R3 may be any one selected from hydrogen, choline, ethanolamine, glycerol, inositol, and serine.

Specifically, R1 may be any one selected from a C5 to C24 saturated or unsaturated straight-chain acyloxy group and derivatives thereof, R2 may be a hydroxy group, and R3 may be ethanolamine.

More specifically, R1 may be a C5 to C24 saturated or unsaturated straight-chain acyloxy group, which may refer to a saturated fatty acid having no double bonds or an unsaturated fatty acid having at least one double bond in the middle of the fatty acid chain. R1 may be a C5 to C24 saturated fatty acid, that is, an acyloxy group having a saturated carbon chain, and may be, for example, any one selected from a pentanoyloxy group, a hexanoyloxy group, a heptanoyloxy group, an octanoyloxy group, a nonanoyloxy group, a decanoyloxy group, an undecanoyloxy group, a dodecanoyloxy group, a tridecanoyloxy group, a tetradecanoyloxy group, a pentadecanoyloxy group, a hexadecanoyloxy group, a heptadecanoyloxy group, an octadecanoyloxy group, a nonadecanoyloxy group, an icosanoyloxy group, a heneicosanoyloxy group, a docosanoyloxy group, a tricosanoyloxy group, a tetracosanoyloxy group, and a derivative thereof. In addition, R1 may be a C5 to C24 unsaturated fatty acid having an unsaturated carbon chain including one double bond, and may be, for example, any one selected from a pentenoyloxy group, a hexenoyloxy group, a heptenoyloxy group, an octenoyloxy group, a nonenoyloxy group, a decenoyloxy group, an undecenoyloxy group, a dodecenoyloxy group, a tridecenoyloxy group, a tetradecenoyloxy group, a pentadecenoyloxy group, a hexadecenoyloxy group, a heptadecenoyloxy group, an octadecenoyloxy group, a nonadecenoyloxy group, an icosenoyloxy group, a heneicosenoyloxy group, a docosenoyloxy group, a tricosenoyloxy group, a tetracosenoyloxy group, and a derivative thereof. In addition, R1 may be a C5 to C24 unsaturated fatty acid having an unsaturated carbon chain including two double bonds, and may be, for example, any one selected from, for example, a cis,cis-9,12-octadecadienoyloxy group (derived from linoleic acid), a cis,cis,cis-9,12,15-octadecatrienoyloxy group (derived from linolenic acid), an arachidonoyloxy group (an eicosatetraenoyloxy group, derived from arachidonic acid), and a derivative thereof.

Considering that a plant surface is highly nonpolar and from the perspective of allowing the active ingredient to effectively penetrate the plant surface or adhere well to the plant surface, R1 may preferably be a C8 to C14 saturated fatty acid, more preferably a C8 to C12 saturated fatty acid, and most preferably a C10 to C12 saturated fatty acid, but is not limited thereto.

Additionally, the derivative may include at least one hydroxy group bonded to at least one carbon within the chemical structure of R1. Specifically, the derivative may include a compound formed through a reaction in which at least one hydroxy group is bonded at a position of R1 having at least one unsaturated bond, such as a double bond, that is, a hydroxylation reaction, and the lysophospholipid formed therethrough may be hydroxylated LPE. Meanwhile, the derivative may also mean that at least one hydroxy group is bonded to or substituted within the chemical structure of R3. The hydroxylation reaction may be carried out by, for example, a chemical method using hydrogen peroxide or a similar peroxide substance, or a biological method using a lipid oxidase such as lipoxygenase.

More specifically, Chemical Formula 1 may be represented by Chemical Formula 3 below.

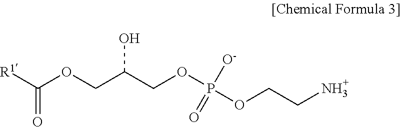

In Chemical Formula 3, R1′ may be any one selected from a C5 to C24 saturated or unsaturated straight-chain alkyl group and a derivative thereof. In addition, the derivative may include at least one hydroxy group bonded to at least one carbon within the chemical structure of R1′.

In one embodiment, Chemical Formula 3 may be LPE, but is not limited thereto.

The LPE is a type of lysophospholipid and may be derived from phosphatidylethanolamine (PE). LPE may have a chemical structure in which one fatty acid at the sn-2 position among the two fatty acids has been removed from PE, which includes two fatty acids, one phosphate group, and ethanolamine bonded thereto on a glycerin backbone.

Since LPE is a substance that is naturally present in plants and animals, a form isolated and purified from natural substances may be used. In particular, LPE may be isolated from lecithin derived from soybean, egg yolk, or rapeseed. Crude soybean lecithin (commonly referred to as crude lecithin), which is produced as a by-product during the soybean oil manufacturing process, includes 60% to 70% polar lipids (phospholipids/glycolipids), 27% to 39% soybean oil, 1% to 3% water, and 0.5% to 3% other components. Among these, the polar lipids are purified by removing soybean oil, which is a neutral lipid contained in the crude lecithin, and may be the soybean lecithin. The composition of purified lecithin includes 22% to 30% phosphatidylcholine (PC), 2% to 5% lysophosphatidylcholine (LPC), 16% to 22% PE, 0.5% to 2% LPE, 0.5% to 8% phosphatidic acid (PA), 0.1% to 3% phosphatidylserine, 6% to 15% phosphatidylinositol, and others. Meanwhile, egg yolk lecithin also includes 73% to 83% PC, 2% to 5% LPC, 13% to 17% PE, 1% to 3% LPE, and others. As such, since lecithin contains only a very small amount of LPE, it is known to be somewhat difficult to directly isolate LPE from these lecithin materials for commercial use. Therefore, LPE prepared by allowing lecithin to react with ethanolamine in the presence of phospholipase D and/or phospholipase A, which are phospholipid hydrolases, may also be used.

In addition, LPE obtained by hydrolyzing PE extracted from natural substances into LPE, or by converting PC into PE and then further hydrolyzing the PE into LPE, may also be used.

In addition, hydrogenated LPE may also be used.

Furthermore, a compound in which at least one hydroxy group has been added at the position of an unsaturated bond, such as a double bond, contained within the remaining one fatty acid chain of LPE, that is, hydroxylated LPE, may also be used.

The lysophospholipid may have a concentration of 0.1% to 20% by weight based on a total weight of the phospholipid composition. Specifically, the lysophospholipid may have a concentration of 0.2% to 10% by weight, more specifically 0.3% to 5% by weight, and 0.5% to 5% by weight in an embodiment, but is not limited thereto. When the lysophospholipid is included within the above-described content range, the lysophospholipid as an active ingredient can be easily dispersed in an aqueous solution, and the effect of inhibiting the degradation of the active ingredient in an aqueous solvent may be exhibited. Meanwhile, when the concentration is below the above-described content range, the amount of the active ingredient in the composition may be too small to exhibit the desired efficacy, whereas when the lysophospholipid is included in excess of the above-described content range, too much lysophospholipid may be included in the aqueous solvent, which may cause a problem in that it is difficult to prepare a homogeneous mixture that can be conveniently used commercially.

Next, the phospholipid composition may include a sulfosuccinate-based surfactant represented by Chemical Formula 2 below.

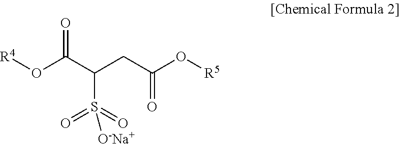

In Chemical Formula 2, R4 and R5 may each independently be hydrogen, sodium, or a C1 to C18 saturated or unsaturated, straight-chain or branched alkyl group. However, R4 and R5 are not both hydrogen or both sodium. In addition, Chemical Formula 2 may include a sulfosuccinate group as an anionic functional group and be present in the form of an alkali salt, such as a sodium salt.

Specifically, R4 and R5 may each independently be a C7 to C8 saturated or unsaturated straight-chain or branched alkyl group. For example, Chemical Formula 2 may include any one selected from dioctyl sulfosuccinate (docusate sodium), ammonium dinonyl sulfosuccinate, diamyl sodium sulfosuccinate, dicapryl sodium sulfosuccinate, diethylhexyl sodium sulfosuccinate, diheptyl sodium sulfosuccinate, dihexyl sodium sulfosuccinate, diisobutyl sodium sulfosuccinate, and ditridecyl sodium sulfosuccinate.

More specifically, in Chemical Formula 2, R4 and R5 may each independently be hydrogen, sodium, or a C8 saturated straight-chain or branched alkyl group. However, R4 and R5 are not both hydrogen or both sodium. In one embodiment, Chemical Formula 2 may include dioctyl sulfosuccinate (docusate sodium), but is not limited thereto.

When the sulfosuccinate-based surfactant is included, the surfactant improves the dispersibility of the above-described lysophospholipid, such as LPE, as an active ingredient of the phospholipid composition of the present invention, enabling the lysophospholipid to be homogeneously dispersed in an aqueous solvent, and additionally has the effect of inhibiting the decomposition of LPE. Specifically, the fatty acid moiety of the surfactant induces physical bonding with LPE, for example, hydrophobic bonding through van der Waals forces, while the sulfosuccinate functional group as a hydrophilic moiety induces chemical bonding with LPE, for example, ionic bonding, thereby effectively suppressing the conventional problem that LPE is easily decomposed in an aqueous solution. In addition, compared to surfactants including other hydrophilic functional groups, such as carboxyl functional groups, the sulfosuccinate-based surfactant has more sites capable of chemical bonding, for example, ionic bonding, with LPE, and thus quantitatively and qualitatively stronger ionic bonding can be induced. Therefore, compared to using other types of surfactants, the use of a sulfosuccinate-based surfactant can enhance the effect of inhibiting LPE decomposition and provide the advantage of maintaining the efficacy of the active ingredient for a longer period of time.

The sulfosuccinate-based surfactant may be included in an amount of 0.1% to 20% by weight based on a total weight of the phospholipid composition. Specifically, the sulfosuccinate-based surfactant may be included in an amount of 0.2% to 10% by weight, more specifically 0.3% to 5% by weight, and 0.5% to 5% by weight in one embodiment, but is not limited thereto. When the sulfosuccinate-based surfactant is included within the above-described content range, the surfactant has the effect of improving the dispersibility and inhibiting the decomposition of LPE in an aqueous solvent. Meanwhile, when the content is below the above-described range, the amount of the sulfosuccinate-based surfactant in the composition may be too small for LPE to be well dispersed in an aqueous solution, making it difficult to prepare a homogeneous phospholipid composition, and the effect of inhibiting the decomposition of LPE may not be exhibited. On the other hand, when the content is more than the above-described range, the amount of the sulfosuccinate-based surfactant in the composition may be too large, resulting in a relatively small amount of LPE as the active ingredient, and thus the desired efficacy of the product may not be exhibited.

In addition, the phospholipid composition of the present invention may further include a nonionic surfactant in addition to the above-described sulfosuccinate-based surfactant, which is an anionic surfactant. The nonionic surfactant may be at least one selected from polysorbate 20 (Tween™ 20), polysorbate 40 (Tween™ 40), polysorbate 60 (Tween™ 60), polysorbate 65 (Tween™ 65), polysorbate 80 (Tween™ 80), polysorbate 85 (Tween™ 85), Triton™ N-101, Triton™ X-100, octoxynol 40, nonoxynol-9, triethanolamine, triethanolamine polypeptide oleate, polyoxyethylene-660 hydroxystearate (PEG-15, Solutol H15), polyoxyethylene-35-ricinoleate (Cremophor EL™), soybean lecithin, poloxamer, and a combination thereof. In one embodiment, the nonionic surfactant may include polysorbate 80 (Tween™ 80), but is not limited thereto, and the content thereof may be 0.1% to 5% by weight, specifically 0.2% to 3% by weight, and more specifically 0.5% to 2% by weight based on a total weight of the composition. By adding a nonionic surfactant within the above-described content range, the dispersibility of LPE in an aqueous solution can be further improved without interfering with the effect of the sulfosuccinate-based surfactant.

In addition, the phospholipid composition of the present invention essentially includes an aqueous solvent, such as water, and may further include an organic solvent. The organic solvent may include alcohols. Specifically, the organic solvent may include a monohydric alcohol including at least one selected from ethanol, propanol, butanol, hexanol, octanol, and a combination thereof; a dihydric alcohol including at least one selected from 1,3-butanediol, 2,3-butanediol, propanediol, hexanediol, octanediol, and a combination thereof; a trihydric alcohol including glycerol; and a mixture of two or more thereof. In one embodiment, the organic solvent may include ethanol, glycerol, and/or a mixture thereof, but is not limited thereto.

Furthermore, the water-soluble phospholipid composition of the present invention may further include a fatty acid additive including a C6 to C24 saturated or unsaturated straight-chain fatty acid; a fatty acid metal salt containing a metal salt of any one selected from Na, K, Mg, Ca, and Al; a fatty acid organic salt containing an organic salt of any one selected from an ethanolamine salt, an ammonium salt, betaine, and a choline salt; or a combination of two or more thereof.

The fatty acid additive may be included in an amount of 1% to 20% by weight based on a total weight of the phospholipid composition, specifically 5% to 17% by weight, and 10% to 15% by weight in one embodiment, but is not limited thereto. When a fatty acid additive within the above-described content range is contained, there is an effect of increasing the solubility of LPE and/or a derivative thereof in the water-soluble composition.

In addition, the phospholipid composition may further include lecithin, hydroxylated lecithin, acetylated lecithin, enzyme-treated lecithin, and a combination of two or more thereof. In one example, lecithin may be additionally included in the phospholipid composition.

In addition, the phospholipid composition may further include a metal ion sequestering agent, for example ethylenediaminetetraacetic tetrasodium salt (EDTA 4Na), a fertilizer nutrient, for example, dipotassium hydrogen phosphate (K₂HPO₄), and the like.

Furthermore, the phospholipid composition of the present invention may be a water-soluble composition in liquid or powder form. Specifically, the phospholipid composition may preferably be in liquid form, and in liquid form using an aqueous solvent in one embodiment, for ease of application to a plant or a part of a plant, such as coating or spraying, but is not limited thereto, and may be handled or prepared in a form suitable for the intended use.

Plant Treatment Agent Including the Phospholipid Composition and Method of Treating with the Same

The plant treatment agent of the present invention may include a phospholipid composition. Various beneficial effects can be delivered by treating a plant or a part of a plant with the plant treatment agent including the phospholipid composition. Specifically, the preferred plant treatment agent of the present invention may be used by diluting the phospholipid composition in a solvent to obtain a composition at an appropriate concentration for application to a plant or a part of a plant.

The phospholipid composition may include a lysophospholipid represented by Chemical Formula 1 and a sulfosuccinate-based surfactant represented by Chemical Formula 2:

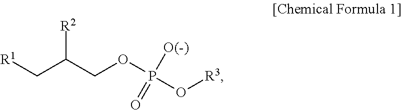

wherein in Chemical Formula 1, R1 is any one selected from a C5 to C24 saturated or unsaturated straight-chain acyloxy group, a C5 to C24 saturated or unsaturated straight-chain alkoxy group, and derivatives thereof; R2 is any one selected from hydrogen, a hydroxy group, a C1 to C5 saturated or unsaturated straight-chain acyloxy group, and a C1 to C5 saturated or unsaturated straight-chain alkoxy group; and R3 is any one selected from hydrogen, choline, ethanolamine, glycerol, inositol, and serine. The specific details of Chemical Formula 1 may be used in the same manner as described in the Phospholipid composition section above.

Additionally, the derivative may include at least one hydroxy group bonded to at least one carbon within the chemical structure of R1. Specifically, the derivative may include a compound formed through a reaction in which at least one hydroxy group is bonded at a position of R1 having at least one unsaturated bond, such as a double bond, that is, a hydroxylation reaction, and the lysophospholipid formed therethrough may be hydroxylated LPE. Meanwhile, the derivative may also mean that at least one hydroxy group is bonded to or substituted within the chemical structure of R3. The hydroxylation reaction may be carried out by, for example, a chemical method using hydrogen peroxide or a similar peroxide substance, or a biological method using a lipid oxidase such as lipoxygenase.

More specifically, Chemical Formula 1 may be represented by Chemical Formula 3 below.

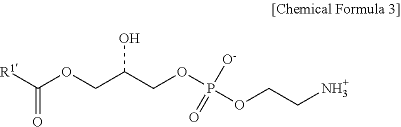

In Chemical Formula 3, R1′ may be any one selected from a C5 to C24 saturated or unsaturated straight-chain alkyl group and a derivative thereof. In addition, the derivative may include at least one hydroxy group bonded to at least one carbon within the chemical structure of R1′.

In one embodiment, Chemical Formula 3 may be LPE, but is not limited thereto.

Next, the phospholipid composition may include a sulfosuccinate-based surfactant represented by Chemical Formula 2 below.

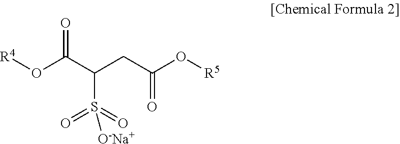

In Chemical Formula 2, R4 and R5 may each independently be hydrogen, sodium, or a C1 to C18 saturated or unsaturated, straight-chain or branched alkyl group. However, R4 and R5 are not both hydrogen or both sodium. In addition, Chemical Formula 2 may include a sulfosuccinate group as an anionic functional group and be present in the form of an alkali salt, such as a sodium salt. The specific details of Chemical Formula 2 may be used in the same manner as described in the Phospholipid composition section above.

More specifically, in Chemical Formula 2, R4 and R5 may each independently be hydrogen, sodium, or a C8 saturated straight-chain or branched alkyl group. However, R4 and R5 are not both hydrogen or both sodium. In one embodiment, Chemical Formula 2 may include dioctyl sulfosuccinate (docusate sodium), but is not limited thereto.

The preferred plant treatment agent according to the present invention may be prepared by diluting the phospholipid composition as an active ingredient in a solvent, such as water, within a range of 10 to 10,000 times. The plant treatment agent may include the lysophospholipid at a concentration of 1 to 5,000 ppm (w/w), specifically 1 to 3,000 ppm (w/w), and more specifically 1 to 1,000 ppm (w/w), but is not limited thereto.

The part of the plant may be, for example, at least one selected from fruit, leaf, flower, root, stem, and tuber. The term “life cycle” may encompass both pre-harvest and post-harvest stages of a plant or a part of a plant.

The plant treatment agent of the present invention may exhibit effects of improving the characteristics and overall health status of a plant or a part of a plant, stimulating growth, and improving a quality attribute such as delaying senescence. The fruit may be at least one selected from apple, pear, tomato, peach, kiwi, plum, cherry, grape, cranberry, blueberry, and strawberry, but is not limited thereto.

Based on these properties, the plant treatment agent of the present invention can be applied in various methods to benefit the plant and agricultural industry. Specifically, at least one of the quality attributes of a plant or a part of a plant, such as color, flavor, hardness, sugar content, fruit cracking, and odor, may be improved by the plant treatment agent of the present invention. In addition, the plant treatment agent of the present invention may exhibit the effect of delaying senescence of a plant or a part of a plant, and through this, may exhibit the effect of extending the storage period or shelf life of a plant or a part of a plant.

Furthermore, the plant treatment agent of the present invention may exhibit the effect of stimulating the growth of a plant or a part of a plant to increase at least one selected from diameter, width, weight, and number of the fruit, vegetable, root, and/or tuber thereof.

Moreover, the plant treatment agent of the present invention may exhibit the effect of protecting a plant or a part of a plant from biotic or abiotic stress. Specifically, the biotic stress may include physical damage caused by a biotic factor including at least one of pathogens (e.g., fungi, protozoa, bacteria, viruses, etc.), insects, nematodes, snails, mites, weeds, humans, animals other than humans, and a combination thereof. The abiotic stress may include physical damage caused by at least one abiotic factor selected from freezing, wind, hail, flooding, drought, heat, and pesticides (e.g., plant growth regulators, insecticides, fungicides, herbicides, spreader-stickers, fertilizers, etc.).

Additionally, the plant treatment agent of the present invention may exhibit the effect of increasing the synthesis of a component selected from starch, protein, lipid, and a combination of two or more thereof in a plant or a part of a plant.

Hereinafter, preferred experimental examples according to the present invention will be described in more detail with reference to the accompanying drawings in order to explain the present invention more specifically. However, the present invention is not limited to the embodiments described herein and may be embodied in other forms.

### Examples 1 to 3: Preparation of Phospholipid Compositions Having Formulations with Improved Long-Term Storage Stability

Phospholipid compositions were prepared by mixing at room temperature a lysophospholipid (LPE) represented by Chemical Formula 1, a sulfosuccinate-based surfactant represented by Chemical Formula 2, an organic solvent (ethanol), water, a nonionic surfactant, glycerol, a fatty acid, lecithin, and K₂HPO₄ in the composition ratios shown in Table 1 below.

### Comparative Example: a Phospholipid Composition Including the Conventional Lysophospholipid

A phospholipid composition was prepared using the same method as in Examples 1 to 3, except that the sulfosuccinate-based surfactant represented by Chemical Formula 2 was not used.

The compositions and contents of the phospholipid compositions corresponding to Examples 1 to 3 and Comparative Example of the present invention are summarized in Table 1 below.

TABLE 1

| Substance | Comparative | | | |
|---|---|---|---|---|
| (Unit: % by weight) | Example | Example 1 | Example 2 | Example 3 |
| LPE | 1 | 1 | 1 | 1 |
| Ethanol | 10 | 10 | 10 | 10 |
| Water | 45 | 44 | 42 | 40 |
| Tween 80 | 1 | 1 | 1 | 1 |
| Glycerol | 20 | 20 | 20 | 20 |
| EDTA 4Na | 2.5 | 2.5 | 2.5 | 2.5 |
| Fatty acids | 11 | 11 | 11 | 11 |
| Lecithin | 6 | 6 | 6 | 6 |
| K₂HPO₄ | 3.5 | 3.5 | 3.5 | 3.5 |
| Surfactant S | 0 | 1 | 3 | 5 |

In Table 1, Surfactant S refers to a sulfosuccinate-based surfactant.

### Test Example 1: Evaluation of Storage Stability of Phospholipid Compositions

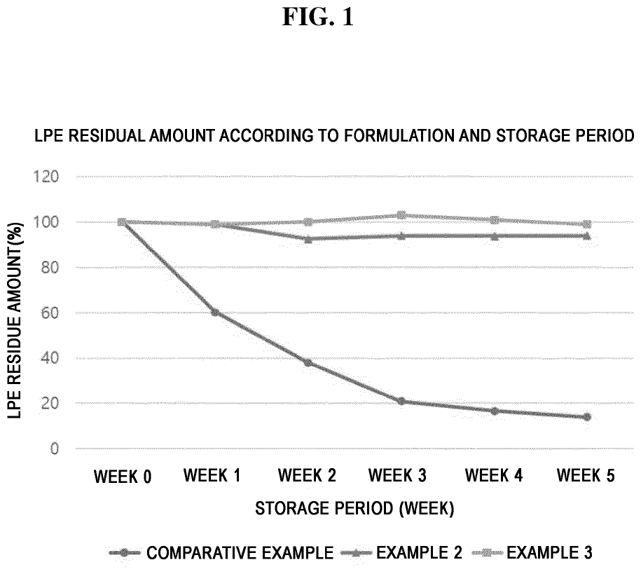

FIG. 1 shows the results of testing the change in residual amount during the storage period according to the type of water-soluble phospholipid composition with improved long-term storage stability according to an embodiment of the present invention.

Referring to FIG. 1, the LPE residual rate in the composition was measured for the phospholipid compositions of Example 2 and Comparative Example of the present invention to confirm whether LPE as an active ingredient remained without decomposition even during long-term storage. In order to evaluate the storage stability of the composition formulation using the water-soluble phospholipid composition used in the examples of the present invention, the composition was stored for a maximum of ten weeks in a constant temperature chamber at 54° C. under harsh test conditions simulating storage at room temperature for six months. The results confirmed that the phospholipid composition including the sulfosuccinate surfactant according to Examples 2 and 3 maintained an LPE residual rate of 94% or more relative to the initial value even after five weeks, and these results may be considered to demonstrate significantly superior storage stability compared to Comparative Example. Therefore, it was confirmed that the aqueous phospholipid composition of the present invention has improved long-term storage stability even in an aqueous solution.

Therefore, in the test examples described below, the phospholipid composition corresponding to the composition of Example 2 may be preferably used as the test group.

### Test Example 2: Test of Control Effect Against Strawberry Powdery Mildew (Sphaerotheca aphanis)

To test the control effect against powdery mildew (Sphaerotheca aphanis) as a target disease using strawberries of the Red Pearl variety as a test crop under greenhouse cultivation, foliar treatment was applied three times at 7-day intervals from the onset of disease. An untreated control was used as Control 1, a 4,000-fold dilution of triflumizole wettable powder (active ingredient content 30%) was used as Control 2, and a 1,000-fold dilution of the phospholipid composition of the present invention (Example 2, active ingredient content 1%) was used as the test group. Regarding the test plot arrangement and required area, a randomized complete block design was performed with three replicates, three treatments, three repetitions, a total of nine plots, and a required area of 180 m². The survey was performed in terms of the disease incidence rate for all fruit in the test plots. The test results on day 7 after the final product treatment are shown in Table 2 below, and it can be confirmed that treatment with the phospholipid composition of the present invention has a control effect against strawberry powdery mildew.

TABLE 2

| | | | | | Significant | |
|---|---|---|---|---|---|---|
| | | | | | difference | |
| | | | | | (Duncan's | Control |
| Treatment | Disease incidence rate | | | | Multiple Range | value |
| Groups | Replication 1 | Replication 2 | Replication 3 | Average | Test: DMRT) | (%) |
| Untreated | 24.4 | 19.8 | 21.8 | 22.0 | c | — |
| (Control Group 1) | | | | | | |
| Triflumizole | 2.5 | 3.5 | 4.0 | 3.3 | a | 85.0 |
| Wettable Powder | | | | | | |
| (Control Group 2) | | | | | | |
| Phospholipid | 7.8 | 8.4 | 8.7 | 8.3 | b | 62.3 |
| Composition | | | | | | |
| (Example 2) | | | | | | |

### Test Example 3: Test of Chemical Control Effect Against Kiwi Canker Disease (Pseudomonas syringae pv. Actinidiae Biovar)

To test the control effect against canker disease (Pseudomonas syringae pv. actinidiae biovar) as a target disease using kiwi of the Jecy Gold variety as a test crop under open field cultivation, foliar treatment was applied three times at 7-day intervals from the onset of disease. An untreated control was used as Control 1, a 1,500-fold dilution of oxytetracycline streptomycin sulfate wettable powder (active ingredient content 20.3% by weight) was used as Control 2, and a 500-fold dilution of the phospholipid composition of the present invention (Example 2, active ingredient content 1% by weight) was used as the test group. Regarding the test plot arrangement and required number of plants, the test was conducted using a completely randomized design with three replications, three treatments, three repetitions, a total of nine plots, one plant per plot, and a total of nine plants required. The survey was performed in terms of the number of diseased leaves out of 200 leaves within the test plots ten days after the final chemical treatment.

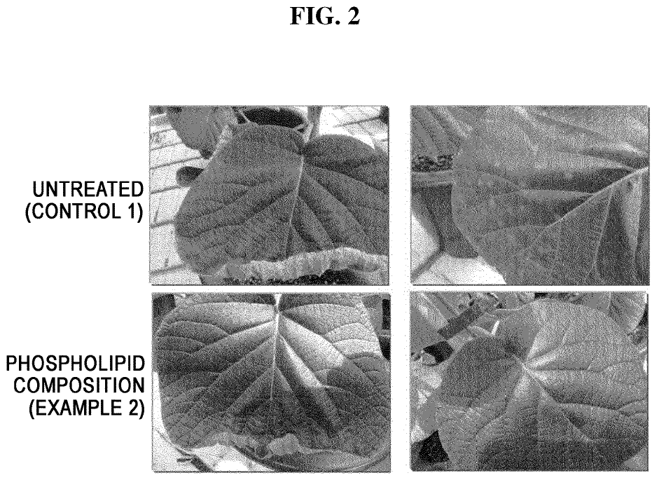

FIG. 2 shows the results of testing the control effect against kiwi canker disease using the phospholipid composition according to an embodiment of the present invention.

The test results on day 7 after the final product treatment are shown in Table 3 and FIG. 2 below, and it can be confirmed that treatment with the phospholipid composition of the present invention has a control effect against kiwi canker disease.

TABLE 3

| | | | | | Significant | Control |
|---|---|---|---|---|---|---|
| Treatment | Disease incidence rate | | | | difference | value |
| Groups | Replication 1 | Replication 2 | Replication 3 | Average | (DMRT) | (%) |
| Untreated | 29.5 | 32.5 | 31.0 | 31.0 | c | — |
| (Control Group 1) | | | | | | |
| Oxytetracycline • | 6.5 | 10.5 | 6.0 | 7.7 | a | 75.2 |
| streptomycin | | | | | | |
| sulfate wettable | | | | | | |
| powder (Control | | | | | | |
| Group 2) | | | | | | |
| Phospholipid | 14.5 | 12.5 | 18.5 | 15.2 | b | 51.0 |
| Composition | | | | | | |
| (Example 2) | | | | | | |

### Test Example 4: Verification Test for Wheat Yield and Protein Enhancement

The effect of increasing wheat yield and protein content was tested using wheat of the Forefront variety as a test crop under open field cultivation. An untreated control was used as the control group, and a 1,000-fold dilution of the phospholipid composition of the present invention (Example 2, active ingredient content 1% by weight) was used as the test group. The treatment timing and method involved treatment five days after anthesis. Regarding the test plot arrangement and required number of plants, the test was conducted using a completely randomized design with three replications, two treatments, one repetition, three experimental plots, an area of 1 ha per plot, and a total required area of 6 ha. The survey was performed in terms of the yield by counting the number of bushels (unit: ton/ha) and the protein content using a whole grain analyzer (unit: %). As shown in Tables 4 and 5 below, the test results showed that compared to the control group conditions of the present invention, the wheat yield increased by approximately 6% to 11% and the wheat protein content increased by approximately 4% to 9% in the test group. Therefore, it can be confirmed that treatment with the phospholipid composition of the present invention has the effect of increasing wheat yield and protein content.

TABLE 4

| Treatment | Yield (ton/ha) | | |
|---|---|---|---|
| group | Experiment 1 | Experiment 2 | Experiment 3 |
| Untreated | 3.6 | 2.8 | 2.9 |
| Example 2 | 3.9 | 3.1 | 3.1 |
| Increase rate | 8.3% | 10.7% | 6.8% |

TABLE 5

| Treatment | Protein content (%) | | |
|---|---|---|---|
| group | Experiment 1 | Experiment 2 | Experiment 3 |
| Untreated | 12.7 | 12.7 | 14.2 |
| Example 2 | 13.6 | 13.8 | 14.7 |
| Increase rate | 7% | 9% | 4% |

### Test Example 5: Test of Cold Damage Inhibition Effect in Apples

Cold damage in fruit refers to a condition in which, when damage occurs around the flowering period, the stigma and ovule turn black, and in severe cases, the flowers fail to bloom and die, or even if they do bloom, the fruit stalk becomes curved without fertilization, resulting in malformed fruit that drops early. The cold damage inhibition effect in apples was tested using apples of the Hongro variety as a test crop under open field cultivation. An untreated control was used as the control group, and a 1,000-fold dilution of the phospholipid composition of the present invention (Example 2, active ingredient content 1% by weight) was used as the test group. The treatment timing and method involved foliar treatment twice at 5-day intervals. Regarding the test plot arrangement and required number of plants, the test was conducted using a completely randomized design with three replications, two treatments, three repetitions, a total of six plots, one plant per plot, and a total of six plants required. The survey was performed in terms of the flowering rate by counting the number of bloomed central flowers per bud, and the fertilization rate by counting the number of fertilized flowers among the bloomed central flowers.

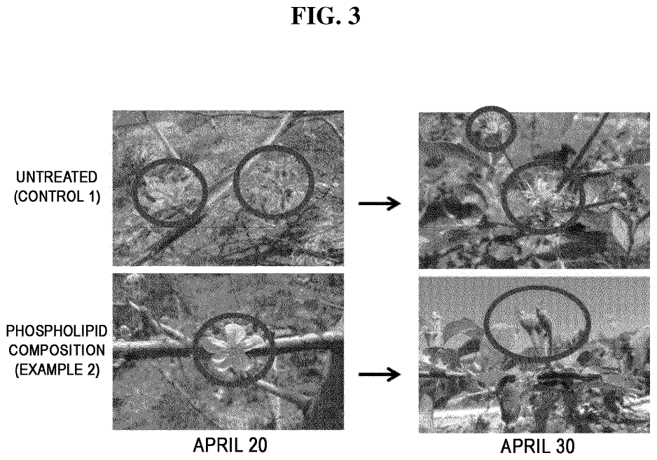

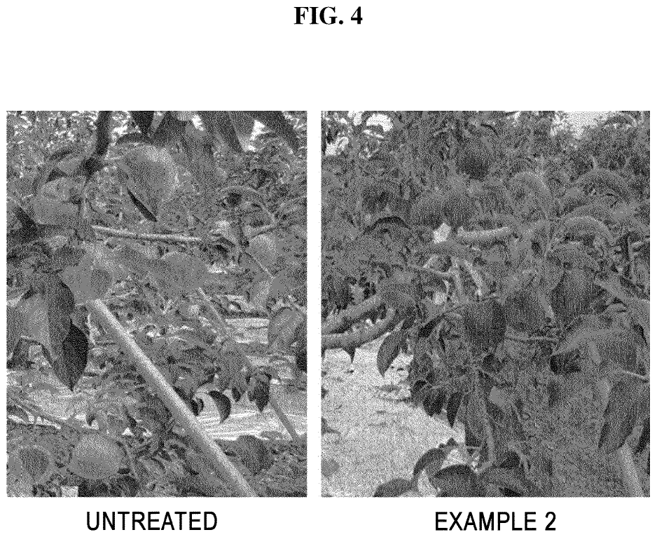

FIG. 3 shows the results of testing the inhibitory effect against cold damage occurrence in Hongro apples using the phospholipid composition according to an embodiment of the present invention, and FIG. 4 shows the results of testing the changes in skin color of the Hongro variety apples before harvest using the phospholipid composition according to an embodiment of the present invention.

As shown in Tables 6 and 7, FIG. 3, and FIG. 4 below, the test results showed that compared to the control group conditions of the present invention, the flowering rate in the test group was approximately 1.8 times higher on average, and the fertilization rate was approximately 1.4 times higher on average. Therefore, it can be confirmed that treatment with the phospholipid composition of the present invention exhibits an inhibitory effect against cold damage occurrence in apples.

TABLE 6

| | Flowering rate | | | | Signif- |
|---|---|---|---|---|---|
| | Repli- | Repli- | Repli- | | icant |
| Treatment | cation | cation | cation | | difference |
| group | 1 | 2 | 3 | Average | (DMRT) |
| Untreated | 10 | 5 | 9 | 8.0 | a |
| Example 2 | 16 | 12 | 15 | 14.3 | b |

TABLE 7

| | Fertilization rate | | | | Signif- |
|---|---|---|---|---|---|
| | Repli- | Repli- | Repli- | | icant |
| Treatment | cation | cation | cation | | difference |
| group | 1 | 2 | 3 | Average | (DMRT) |
| Untreated | 38 | 32 | 43 | 37.6 | a |
| Example 2 | 54 | 47 | 62 | 54.3 | b |

### Test Example 6: Coloration Promotion Screening Test for Apples

A coloration promotion screening test (first trial) for apples was conducted at the National Institute of Horticultural and Herbal Science of the Rural Development Administration, using apples of the Picnic variety as a test crop. The phospholipid composition of the present invention (denoted as LPE) was applied by spray treatment at concentrations of 0 mg·L⁻¹ (untreated), 20 mg·L⁻¹ (Example 2 (1)), and 40 mg·L⁻¹ (Example 2 (2)), and the treatment was performed by a first treatment six weeks before harvest, a second treatment four weeks before harvest, and a third treatment two weeks before harvest. The coloration of apples was measured using a Hunter colorimeter to determine the Hunter “a” value, which indicates the degree of redness of the fruit skin, with a higher “a” value indicating a deeper red color and greater promotion of apple coloration.

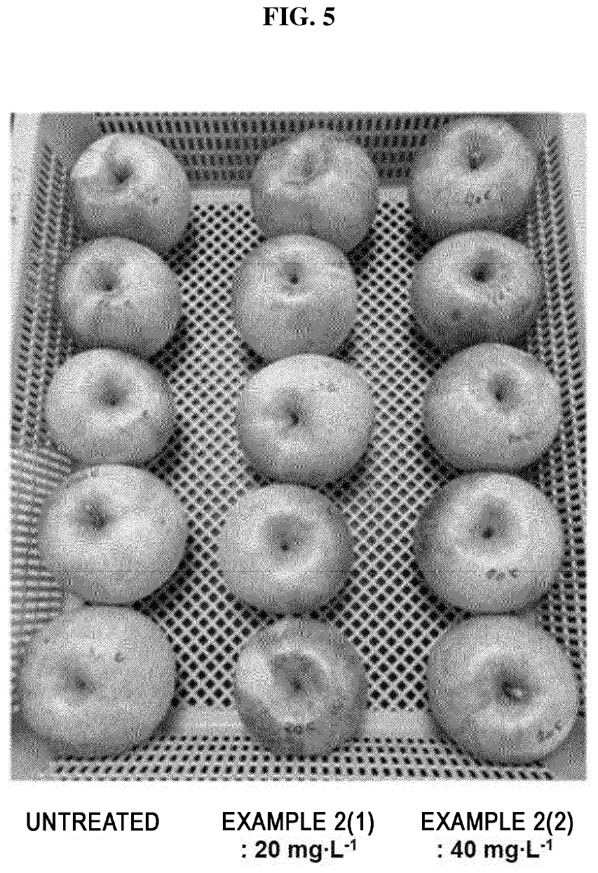

FIG. 5 shows the results of testing the coloration promotion in Picnic variety apples using the phospholipid composition according to an embodiment of the present invention.

As shown in Table 8 and FIG. 5 below, as a result of measuring the changes in apple skin color for the Picnic variety, the measured “a” value was high in both the reddest part (denoted as Red part) and the least red part (denoted as Non-red part) of the fruit in the test group treated with the phospholipid composition of the present invention, and it can particularly be confirmed that the measured “a” value was highest under the 20 mg·L⁻¹ (Example 2 (1)) condition. These results confirmed that apple coloration can be promoted through the treatment with the phospholipid composition of the present invention.

TABLE 8

| Phospholipid composition | | Red part | | | Non-red part | | |
|---|---|---|---|---|---|---|---|
| concentration (mg · L⁻¹) | | L* | a* | b* | L* | a* | b* |
| 0 | (untreated) | 50.45 | 26.98 | 23.21 | 76.20 | −3.10 | 39.96 |
| 20 | (Example 2(1)) | 39.97 | 35.25 | 17.86 | 67.88 | 7.55 | 34.85 |
| 40 | (Example 2) | 40.91 | 34.63 | 18.15 | 73.76 | −0.47 | 38.33 |

Next, a coloration promotion screening test (second trial) for apples was conducted at an apple farm in Cheongsong using the Fuji variety as a test crop. The phospholipid composition of the present invention was applied by spray treatment at concentrations of 0 mg·L⁻¹ (untreated) and 20 mg·L⁻¹ (Example 2 (1)), and the treatment was performed by a first treatment five weeks before harvest and a second treatment three weeks before harvest.

As shown in Table 9 below, as a result of measuring the changes in apple skin color for the Fuji variety, it can be confirmed that the measured “a” value was high in both the reddest part (denoted as Red part) and the least red part (denoted as Non-red part) of the fruit in the test group treated with the phospholipid composition of the present invention (denoted as LPE treatment group) compared to the untreated control group. These results confirmed that apple coloration can be promoted through the treatment with the phospholipid composition of the present invention.

TABLE 9

| | |
|---|---|
| Untreated group | LPE treatment group |

| | Non-red | Red | Non-red | Red |
|---|---|---|---|---|
| L* | 61.3 ± 2.4 | 45.6 ± 2.4 | 57.1 ± 4.4 | 40.1 ± 1.3 |
| a* | 8.0 ± 4.9 | 26.7 ± 3.3 | 17.2 ± 6.5 | 28.8 ± 2.8 |
| b* | 28.8 ± 4.0 | 17.5 ± 2.3 | 25.6 ± 3.9 | 13.9 ± 0.7 |

### Test Example 7: Coloration Promotion Screening Test for Grapes

A coloration promotion screening test for grapes was conducted at a grape farm in Siheung using the Campbell Early (Vitis labrusca L.) variety as a test crop. The phospholipid composition of the present invention (denoted as LPE) was applied by spray treatment at concentrations of 0 mg·L⁻¹ (untreated), 20 mg·L⁻¹ (Example 2 (1)), and 40 mg·L⁻¹ (Example 2 (2)), and the treatment was performed by a first treatment four weeks before harvest and a second treatment two weeks before harvest. The coloration of grapes was measured by visual observation of color change (visible difference) and using a Hunter colorimeter to determine the Hunter “L” value, “a” value, and “b” value, which indicate the degree of redness of the fruit skin, with a higher “a” value indicating a deeper red color, a higher “b” value indicating a deeper blue color, and a lower “L” value indicating a darker color closer to black.

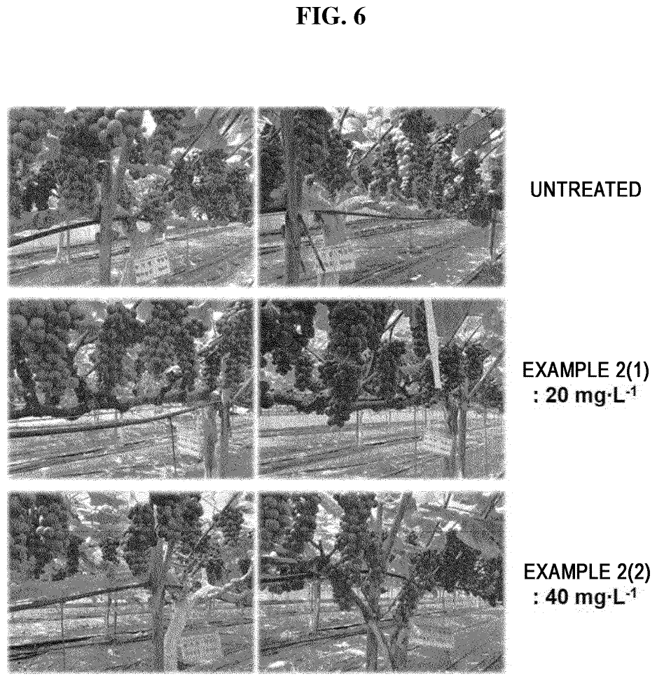

FIG. 6 shows the results of testing the coloration promotion in Campbell Early variety grapes using the phospholipid composition according to an embodiment of the present invention.

As shown in Table 10 and FIG. 6 below, as a result of measuring the changes in grape skin color for the Campbell Early variety, it was confirmed that the color observed visually became more vivid in all test group fruits treated with the phospholipid composition of the present invention compared to the untreated control group, and it was confirmed that the “L” value decreased the most, indicating a darker color, while the “a” value and “b” value also decreased, indicating a reduction in red and blue. These results confirmed that grape coloration can be promoted through treatment with the phospholipid composition of the present invention.

TABLE 10

| Phospholipid composition | | | |
|---|---|---|---|
| concentration (mg · L⁻¹) | L* | a* | b* |
| 0 (untreated) | 24.4 ± 2.3 | 3.6 ± 1.5 | −3.0 ± 1.2 |
| 20 (Example 2(1)) | 18.6 ± 3.5 | −0.8 ± 1.1 | −2.6 ± 1.1 |
| 40 (Example 2(2)) | 21.8 ± 3.4 | 0.4 ± 1.7 | −2.4 ± 1.3 |
| Average | 21.6 | 1.07 | −2.7 |

### Test Example 8: Coloration Promotion Test for Apples According to Formulation of the Phospholipid Composition

A screening evaluation test was conducted to determine whether the phospholipid composition of the present invention with improved storage stability exhibits apple coloration efficacy similar to that of conventionally used formulations even when the formulation is used seven days after preparation. A coloration promotion screening test for apples was conducted at the National Institute of Horticultural and Herbal Science of the Rural Development Administration, using apples of the Picnic variety as a test crop. Spray foliar treatment was performed in a group with no phospholipid composition treatment (untreated), a group treated at 20 mg·L⁻¹ with the formulation of Comparative Example seven days after preparation (denoted as Comparative Example (seven days elapsed)), and a group treated at 20 mg·L⁻¹ with the formulation of Example 2 of the present invention seven days after preparation (denoted as Example 2 (seven days elapsed)), and the treatment was performed by a first treatment six weeks before harvest and a second treatment four weeks before harvest. The coloration of apples was measured using a Hunter colorimeter to determine the Hunter “a” value, which indicates the degree of redness of the fruit skin, with a higher “a” value indicating a deeper red color and greater promotion of apple coloration.

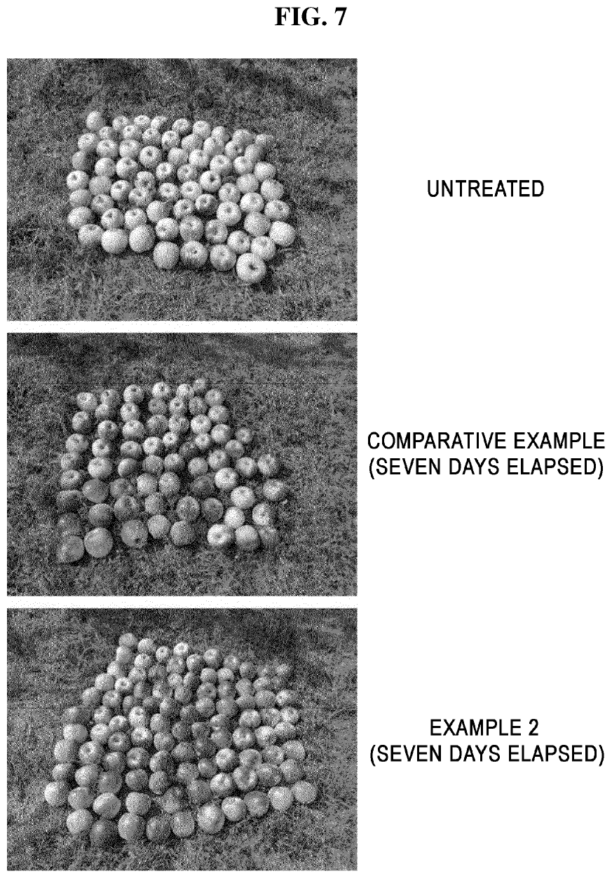

FIG. 7 shows the results of testing the coloration promotion in Picnic variety apples using the phospholipid composition seven days after preparation according to an embodiment of the present invention.

As shown in Table 11 and FIG. 7 below, as a result of measuring the changes in apple skin color for the Picnic variety according to the phospholipid composition formulation, it can be confirmed that the measured “a” value was high in both the reddest part (denoted as Red part) and the least red part (denoted as Non-red part) of the fruit compared to the untreated control, and that apple coloration can be promoted.

TABLE 11

| | Red part | | | Non-red part | | |
|---|---|---|---|---|---|---|
| LPE | L* | a* | b* | L* | a* | b* |
| Untreated | 50.45a | 16.98a | 23.21a | 76.20a | −5.10a | 39.96a |
| Comparative | 39.97b | 25.25b | 17.86b | 71.88ab | 2.55b | 34.85b |
| Example | | | | | | |
| (seven days | | | | | | |
| elapsed) | | | | | | |
| Example 2 | 40.91b | 24.63b | 18.15b | 69.76bc | 4.47b | 32.33b |
| (seven days | | | | | | |
| elapsed) | | | | | | |

### Test Example 9: Coloration Promotion Test for Apples According to Elapsed Time of the Phospholipid Composition

Changes in the content of the active substance LPE in the phospholipid composition according to the present invention according to the storage period after preparation were confirmed.

Referring to Table 12 below, as a result of measuring the change in the content of LPE remaining in the phospholipid composition product, it can be confirmed that in the case of the Example, a higher content was maintained compared to Comparative Example both seven days and twelve months after preparation.

TABLE 12

| | |
|---|---|
| LPE 1% by weight | LPE content |

| soluble concentrate | Seven days after | Twelve months after |
|---|---|---|
| (SL) formulation | preparation | preparation |
| Comparative Example | 0.99 | 0.35 |
| Example 2 | 1.02 | 0.93 |

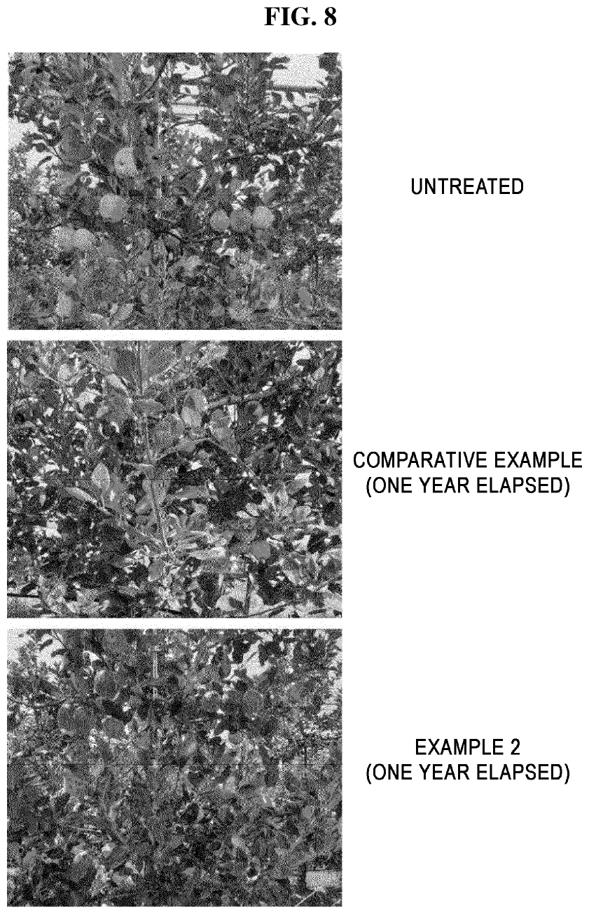

FIG. 8 shows the results of measuring the change in skin color of Picnic variety apples using the phospholipid composition one year after preparation according to an embodiment of the present invention.

In addition, referring to Table 13 and FIG. 8 below, as a result of measuring changes in apple skin color for the Picnic variety when using a product one year after preparation, it can be confirmed that the measured “a” value was high in both the reddest part (denoted as Red part) and the least red part (denoted as Non-red part) of the fruit compared to the untreated control and Comparative Example, and that apple coloration can be promoted. The results confirmed that there was almost no difference in coloration between the untreated control and Comparative Example.

TABLE 13

| Phospholipid | Red part | | | Non-red part | | |
|---|---|---|---|---|---|---|
| composition | L* | a* | 0 | L* | a* | b* |
| Untreated | 49.45a | 16.88a | 27.81a | 71.20a | −4.01a | 33.06a |
| Comparative | 47.97b | 17.24a | 25.44ab | 70.88a | −1.55ab | 31.85ab |
| Example (one | | | | | | |
| year elapsed) | | | | | | |
| Example 2 (one | 38.91b | 26.55b | 18.15c | 49.76b | 7.32c | 22.68c |
| year elapsed) | | | | | | |

### Test Example 10: Coloration Promotion Test for Grapes According to Formulation of the Phospholipid Composition

A screening evaluation test was conducted to determine whether the phospholipid composition of the present invention with improved storage stability exhibits grape coloration efficacy similar to that of conventionally used formulations even when the formulation is used seven days after preparation. A coloration promotion screening test for grapes was conducted at a grape farm in Siheung using the Campbell Early (Vitis labrusca L.) variety as a test crop. Spray foliar treatment was performed in a group with no phospholipid composition treatment (untreated), a group treated at 20 mg·L⁻¹ with the formulation of Comparative Example seven days after preparation (denoted as Comparative Example (seven days elapsed)), and a group treated at 20 mg·L⁻¹ with the formulation of Example 2 of the present invention seven days after preparation (denoted as Example 2 (seven days elapsed)), and the treatment was performed by a first treatment four weeks before harvest and a second treatment two weeks before harvest. Visual observation was used as the method for confirming grape coloration.

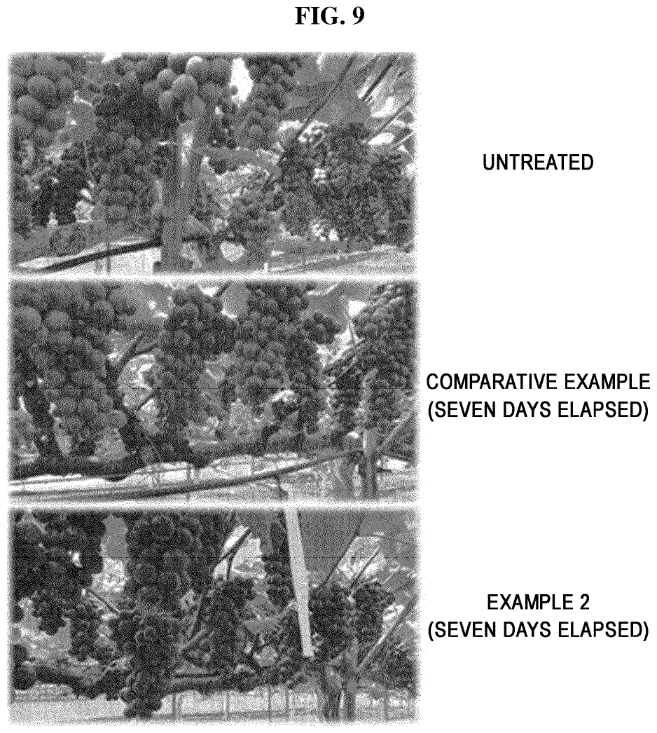

FIG. 9 shows the results of testing the coloration promotion in Campbell Early variety grapes using the phospholipid composition seven days after preparation according to an embodiment of the present invention.

Referring to FIG. 9, as a result of visually observing changes in grape skin color for the Campbell Early variety according to the phospholipid composition formulation, the difference between the formulations of Comparative Example and Example 2 was almost non-distinguishable, but it can be confirmed that grape coloration was visually promoted in both Comparative Example and Example 2 treatment groups compared to the untreated control.

In addition, referring to Table 14 below, the anthocyanin content in Campbell Early grapes was measured using the phospholipid composition formulation seven days after preparation. The anthocyanin content in the fruit skin was determined by collecting ten fruit skin sections from the equatorial plane of the berries using a cork borer (5 mm), immersing the collected sections in a 0.1 N HCl-100% EtOH (15:85, V/V) solution, storing the sections in a cold and dark place for 24 hours, measuring the absorbance at 535 nm using a spectrophotometer (UV-2501 PC, Shimadzu, Japan), and calculating the total anthocyanin content using the method of Fuleki & Francis (1968a, 1968b). The results confirmed that when the LPE formulation was used seven days after preparation (Example 2), grape coloration was promoted and the anthocyanin content was increased by the LPE treatment regardless of the formulation type.

TABLE 14

| | Anthocyanin | Significant difference |
|---|---|---|
| Treatment group | (mg/L) | (DMRT) |
| Untreated | 1.5 ± 0.5 | a |
| Comparative Example | 2.7 ± 0.3 | b |
| (seven days elapsed) | | |
| Example 2 | 2.9 ± 0.2 | b |
| (seven days elapsed) | | |

### Test Example 11: Coloration Promotion Test in Grapes According to Elapsed Time of the Phospholipid Composition

Changes in the content of the active substance LPE in the phospholipid composition according to the present invention according to the storage period after preparation were confirmed.

Referring to Table 15 below, as a result of measuring the change in the content of LPE remaining in the product according to the storage period of the phospholipid composition, it can be confirmed that in the case of Example, a higher content was maintained compared to Comparative Example both seven days after preparation and twelve months after preparation.

TABLE 15

LPE content

| LPE 1% by weight | Seven days after | Twelve months after |
|---|---|---|
| SL formulation | preparation | preparation |
| Comparative Example | 0.99 | 0.35 |
| Example 2 | 1.02 | 0.93 |

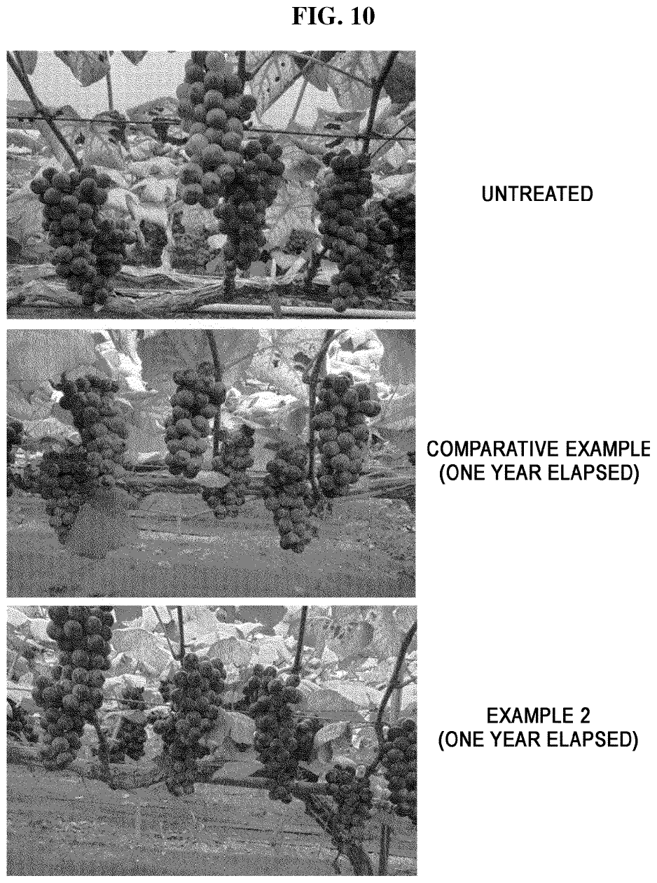

FIG. 10 shows the results of observing the change in skin color of Campbell Early variety grapes using the phospholipid composition one year after preparation according to an embodiment of the present invention.

Referring to FIG. 10, as a result of visually observing changes in grape skin color for the Campbell Early variety using the phospholipid composition one year after preparation, almost no difference in coloration was observed between the untreated control and Comparative Example, but it can be confirmed that the color of the grapes became deeper and coloration was promoted in Example 2 compared to the untreated control or Comparative Example.

In addition, referring to Table 16 below, it can be confirmed that the anthocyanin concentration in the Campbell Early variety grapes was higher in Example compared to the untreated control or Comparative Example.

TABLE 16

| | Anthocyanin | Significant difference |
|---|---|---|
| Treatment group | (mg/L) | (DMRT) |
| Untreated | 2.5 ± 0.5 | a |
| Comparative Example | 3.1 ± 0.3 | ab |
| (one year elapsed) | | |
| Example 2 | 4.0 ± 0.1 | c |
| (one year elapsed) | | |

Meanwhile, the embodiments of the present invention disclosed in the present specification and drawings are merely presented as specific examples to aid understanding, and are not intended to limit the scope of the present invention. It will be apparent to those skilled in the art to which the present invention pertains that other modifications based on the technical spirit of the present invention can be implemented in addition to the embodiments disclosed herein.

1. A phospholipid composition comprising a lysophospholipid represented by Chemical Formula 1 and a sulfosuccinate-based surfactant represented by Chemical Formula 2: 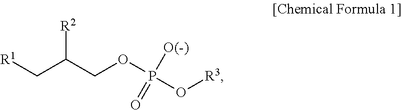
wherein in Chemical Formula 1, R1 is any one selected from a C5 to C24 saturated or unsaturated straight-chain acyloxy group, a C5 to C24 saturated or unsaturated straight-chain alkoxy group, and derivatives thereof;
R2 is any one selected from hydrogen, a hydroxy group, a C1 to C5 saturated or unsaturated straight-chain acyloxy group, and a C1 to C5 saturated or unsaturated straight-chain alkoxy group; and
R3 is any one selected from hydrogen, choline, ethanolamine, glycerol, inositol, and serine, 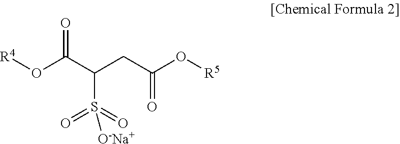
wherein in Chemical Formula 2, R4 and R5 are each independently hydrogen, sodium, or a C1 to C18 saturated or unsaturated, straight-chain or branched alkyl group, and R4 and R5 are not both hydrogen or both sodium.

2. The phospholipid composition according to claim 1, wherein the derivatives include at least one hydroxy group bonded to at least one carbon within the chemical structure of R1.

3. The phospholipid composition according to claim 1, wherein the phospholipid composition is a water-soluble composition in liquid or powder form.

4. The phospholipid composition according to claim 1, wherein the lysophospholipid has a concentration of 0.1% to 20% by weight based on a total weight of the phospholipid composition.

5. The phospholipid composition according to claim 1, wherein the sulfosuccinate-based surfactant is included in an amount of 0.1% to 20% by weight based on a total weight of the phospholipid composition.

6. The phospholipid composition according to claim 1, wherein the phospholipid composition further comprises a fatty acid additive including:
a C6 to C24 saturated or unsaturated straight-chain fatty acid;
a fatty acid metal salt containing a metal salt of any one selected from Na, K, Mg, Ca, and Al;
a fatty acid organic salt containing an organic salt of any one selected from an ethanolamine salt, an ammonium salt, betaine, and a choline salt; or
a combination of two or more thereof.

7. The phospholipid composition according to claim 6, wherein the fatty acid additive is included in an amount of 1% to 20% by weight based on a total weight of the phospholipid composition.

8. The phospholipid composition according to claim 1, wherein the phospholipid composition further comprises an organic solvent including:
a monohydric alcohol including at least one selected from ethanol, propanol, butanol, hexanol, octanol, and a combination thereof;
a dihydric alcohol including at least one selected from 1,3-butanediol, 2,3-butanediol, propanediol, hexanediol, octanediol, and a combination thereof;
a trihydric alcohol including glycerol; and
a mixture of two or more thereof.

9. The phospholipid composition according to claim 1, wherein the phospholipid composition further comprises lecithin, hydroxylated lecithin, acetylated lecithin, enzyme-treated lecithin, or a combination of two or more thereof.

10. A method comprising a step of treating a plant or a part of a plant with a plant treatment agent including a phospholipid composition to alter health status, growth, or life cycle of the plant or the part of the plant,
wherein the phospholipid composition including a lysophospholipid represented by Chemical Formula 1 and a sulfosuccinate-based surfactant represented by Chemical Formula 2: 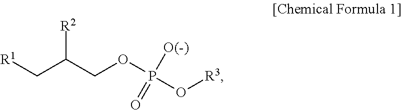
wherein in Chemical Formula 1, R1 is any one selected from a C5 to C24 saturated or unsaturated straight-chain acyloxy group, a C5 to C24 saturated or unsaturated straight-chain alkoxy group, and derivatives thereof;
R2 is any one selected from hydrogen, a hydroxy group, a C1 to C5 saturated or unsaturated straight-chain acyloxy group, and a C1 to C5 saturated or unsaturated straight-chain alkoxy group; and
R3 is any one selected from hydrogen, choline, ethanolamine, glycerol, inositol, and serine, 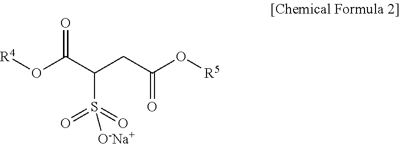
wherein in Chemical Formula 2, R4 and R5 are each independently hydrogen, sodium, or a C1 to C18 saturated or unsaturated, straight-chain or branched alkyl group, and R4 and R5 are not both hydrogen or both sodium.

11. The method according to claim 10, wherein the derivatives include at least one hydroxy group bonded to at least one carbon within the chemical structure of R1.

12. The method according to claim 10, wherein the plant treatment agent is an aqueous solution including the lysophospholipid at a concentration of 1 to 5,000 ppm (w/w).

13. The method according to claim 10, wherein the part of the plant is at least one selected from fruit, leaf, flower, root, stem, and tuber.

14. The method according to claim 10, wherein the method improves a quality attribute of a plant or a part of a plant.

15. The method according to claim 10, wherein the method delays senescence of a plant or a part of a plant.

16. The method according to claim 10, wherein the method stimulates growth of a plant or a part of a plant to increase at least one selected from diameter, width, weight, and number of fruit, vegetable, root, and/or tuber thereof.

17. The method according to claim 10, wherein the method protects a plant or a part of a plant from biotic or abiotic stress.

18. The method according to claim 17, wherein the abiotic stress includes physical damage caused by at least one abiotic factor selected from freezing, wind, hail, flooding, drought, heat, and pesticides.

19. The method according to claim 17, wherein the biotic stress includes physical damage caused by a biotic factor including at least one of pathogens, insects, nematodes, snails, mites, weeds, humans, and animals other than humans.

20. The method according to claim 10, wherein the method increases synthesis of a component selected from starch, protein, lipid, and a combination of two or more thereof in a plant or a part of a plant.
